(19) United States
(12) Patent Application Publication
(10) Pub. No.: US 2015/0117061 A1
(43) Pub. Date: Apr. 30, 2015

(54) POWER SUPPLY APPARATUS

(71) Applicant: SAMSUNG ELECTRO-MECHANICS CO., LTD., Suwon (KR)

(72) Inventors: Chong Eun KIM, Suwon (KR); Jeong Nam LEE, Suwon (KR)

(21) Appl. No.: 14/308,935

(22) Filed: Jun. 19, 2014

(30) Foreign Application Priority Data
Oct. 31, 2013 (KR) 10-2013-0131558

(51) Int. Cl. H02M 3/335

(52) U.S. Cl. CPC H02M 3/33507; H02M 2001/0054
USPC 363/17

(57) ABSTRACT

A power supply apparatus may include: a power supplying unit switching input power and supplying driving power; and a controlling unit controlling supplying of power by the power supplying unit by fixing a power switching phase and duty to a preset value and varying a switching frequency thereof in a case in which a load state of the power supplying unit is equal to a preset load state or above, and by varying the power switching phase and the switching frequency of the power supplying unit in a case in which the load state of the power supplying unit is a preset load state or less.

### CROSS-REFERENCE TO RELATED APPLICATION

This application claims the benefit of Korean Patent Application No. 10-2013-0131558 filed on Oct. 31, 2013, with the Korean Intellectual Property Office, the disclosure of which is incorporated herein by reference.

### BACKGROUND

The present disclosure relates to a power supply apparatus using a phase shift full bridge scheme.

In recent, several kinds of electronic apparatuses, meeting various user requirements, such as computers, display devices, a variety of controllers, and the like have been used in various spaces such domestic, commercial and industrial spaces, and the like.

Such electronic apparatuses necessarily require a power supply apparatus providing driving power thereto and disposed outside or inside the electronic apparatuses to perform various operations which meet varying user requirements.

Particularly, an electronic apparatus such as a server continuously operating and using high capacity power necessarily requires a power supply apparatus.

Meanwhile, high efficiency has been required in a light load condition. This is due to a parallel driving structure of a power supply apparatus for a server and operational characteristics of the power supply apparatus for the server.

That is, in order to satisfy the demand for high reliability, such a power supply apparatus for a server uses the parallel driving structure in order to smoothly supply output power when the supplying of power by one power supply apparatus among a plurality of power supply apparatuses is disabled. Since the number of users of a data center is sharply decreased at certain hours of the day, such as dawn, the power supply apparatus for the server may be operated in a light load region.

In general, as a DC/DC converting unit of the power supply apparatus for the server, a full bridge converter is widely used according to the requirement for a high power specification. In this case, zero voltage switching is possible by using a phase shift control, such that switching loss may be reduced.

This is due to the fact that in the case of the phase shift full bridge converter, a semiconductor device has a low level of stress, may perform zero voltage switching, and is suitable for a large capacity application.

In addition, in a case of having a high current output condition as in the power supply apparatus for the server, the power supply apparatus for the server may significantly reduce conduction loss by using a synchronous rectifier (SR) switch in a secondary side rectifying stage.

In a typical case, the SR switch is controlled using an OR-gated signal of a primary side control signal. In this case, since the power supply apparatus loses zero voltage switching characteristics in the light load region and an output inductor is operated in a continuous current mode, a predetermined amount of magnetic loss is caused, such that efficiency may be decreased.

Therefore, a phase shift full bridge converter capable of significantly reducing switching loss and magnetic loss, the leading causes of decreases in efficiency in the light load region, has been demanded.

Patent Document 1 relates to a phase shift full bridge (PSFB) converter but does not disclose a detailed configuration for significantly reducing switching loss and magnetic loss in a light load region.

### RELATED ART DOCUMENT

(Patent Document 1) Japanese Patent Laid-Open Publication No. JP2005-348567

### SUMMARY

An aspect of the present invention provides a power supply apparatus using a phase shift full bridge scheme, the power supply apparatus having improved power conversion efficiency in a light load condition.

According to an aspect of the present disclosure, a power supply apparatus may include: a power supplying unit switching input power and supplying driving power; and a controlling unit controlling supplying of power by the power supplying unit by fixing a power switching phase and a power switching duty of the power supplying unit to preset values and varying a switching frequency of the power supplying unit in a case in which a load state of the power supplying unit is equal to or greater than a preset load state, and by varying the power switching phase and the switching frequency of the power supplying unit in a case in which the load state of the power supplying unit is equal to or lower than the preset load state.

The power supplying unit may include: a switching unit switching the input power according to a control of the controlling unit; a transforming unit transforming the power switched by the switching unit; and an outputting unit stabilizing and outputting the power transformed by the transforming unit.

The switching unit may perform the switching in a phase shift full bridge scheme.

The transforming unit may include: a resonance tank performing an inductor-inductor-capacitor (LLC) resonance; and a transformer transforming the power switched by the switching unit according to a turns ratio between a primary winding and a secondary winding each having a predetermined amount of turns.

The controlling unit may include: a duty controlling unit detecting a current of the driving power from the power supplying unit and controlling the power switching duty; a frequency controlling unit detecting a voltage of the driving power from the power supplying unit and controlling the switching frequency of the power supplying unit; a driving controlling unit generating driving signals according to a control of the duty controlling unit and the frequency controlling unit; and a gate driver providing gate signals allowing for switching of power according to the driving signals from the driving controlling unit.

The duty controlling unit and the frequency controlling unit may be formed at a secondary side having a preset ground, the driving controlling unit and the gate driver may be formed at a primary side having a ground having electrical characteristics different from those of the ground of the secondary side, and the controlling unit may further include a transferring unit transferring control signals from the duty controlling unit and the frequency controlling unit of the secondary side to the driving controlling unit of the primary side.

According to another aspect of the present disclosure, a power supply apparatus may include: a power supplying unit switching input power in a phase shift full bridge scheme and supplying driving power; and a controlling unit controlling supplying of power by the power supplying unit by fixing a power switching phase of the power supplying unit to a preset value and varying a switching frequency of the power supplying unit in a case in which a load state of the power supplying unit is equal to or greater than a preset load state, and by varying the power switching phase and the switching frequency of the power supplying unit in a case in which the load state of the power supplying unit is equal to or lower than the preset load state.

The controlling unit may fix a switching duty of the power supplying unit to a preset value in a case in which the load state of the power supplying unit is equal to or greater than a preset load state.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a schematic circuit diagram of a power supply apparatus according to an exemplary embodiment of the present disclosure;

FIGS. 2A and 2B are graphs showing switching schemes depending on load states of the power supply apparatus according to an exemplary embodiment of the present disclosure; and

FIGS. 3A and 3B are graphs showing operational waveforms of main components according to the switching schemes of the power supply apparatus according to an exemplary embodiment of the present disclosure.

### DETAILED DESCRIPTION

Exemplary embodiments of the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

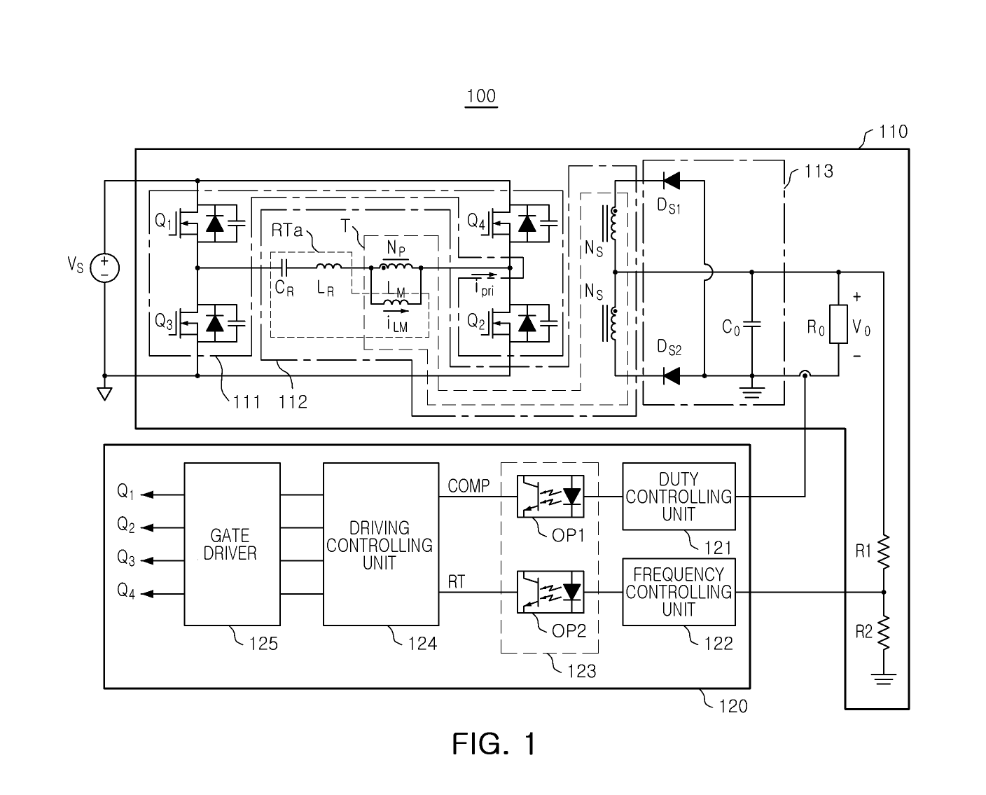

FIG. 1 is a schematic circuit diagram of a power supply apparatus according to an exemplary embodiment of the present disclosure.

Referring to FIG. 1, a power supply apparatus 100 according to an exemplary embodiment of the present disclosure may include a power supplying unit 110 and a controlling unit 120.

The power supplying unit 110 may include a switching unit 111, a transforming unit 112, and an outputting unit 113.

The switching unit 111 may include a phase shift full bridge.

The phase shift full bridge may include first and second leading leg switches Q1 and Q2, and first and second lagging leg switches Q3 and Q4. The first and second leading leg switches Q1 and Q2, and the first and second lagging leg switches Q3 and Q4 may respectively perform switching on or off, and the switching thereof may be controlled in a phase shift scheme.

The transforming unit 112 may include an LLC resonance tank RTa and a transformer T.

The LLC resonance tank RTa may perform an inductor L_{R}-inductor L_{O}-capacitor C_{R} (LLC) resonance, and the inductor L_{M} may be a magnetized inductor of the transformer T.

The transformer T may have a primary winding Np disposed at a primary side and having a preset ground and a secondary winding Ns disposed at a secondary side insulated from and magnetically coupled to the primary winding Np and having a ground electrically different from that of the primary side, the primary winding Np and secondary winding Ns being electrically separated from each other.

Each of the primary winding Np and the secondary winding Ns may have a predetermined amount of turns, and the primary winding Np and the secondary winding Ns may form a preset turns ratio to transform and output power switched by the switching unit 111 according to the turns ratio.

The outputting unit 113 may include first and second diodes Ds1 and Ds2 each rectifying the transformed power provided from the secondary winding Ns and a capacitor Co stabilizing the power rectified by the first and second diodes Ds1 and Ds2.

The controlling unit 120 may provide gate signals Q1, Q2, Q3, and Q4 controlling switching of the first and second leading leg switches Q1 and Q2, and the first and second lagging leg switches Q3 and Q4 of the switching unit 111 depending on a load state.

The controlling unit 120 may include a duty controlling unit 121, a frequency controlling unit 122, a transferring unit 123, a driving controlling unit 124, and a gate driver 125.

The duty controlling unit 121 may control a switching duty of the switching unit 111 according to a detected value obtained by detecting a current of driving power of the power supplying unit 110.

The frequency controlling unit 122 may control a switching frequency of the switching unit 111 according to a detected value obtained by detecting a voltage of the driving power of the power supplying unit 110.

The driving controlling unit 124 may generate driving signals capable of controlling the switching of the respective switches included in the phase shift full bridge of the switching unit 111 according to control signals of the duty controlling unit 121 and the frequency controlling unit 122.

The driving signals may be pulse width and phase modulation PW&PM signals modulating a pulse width and phase.

The gate driver 125 may provide the gate signals Q1, Q2, Q3, and Q4 capable of driving the respective switches of the phase shift full bridge of the switching unit 111 to gates of the first and second leading leg switches Q1 and Q2 and the first and second lagging leg switches Q3 and Q4 of the switching unit 111 based on the driving signals from the driving controlling unit 124.

Meanwhile, the duty controlling unit 121 and the frequency controlling unit 122 may be formed at the secondary side and the driving controlling unit 124 and the gate driver 125 may be formed at the primary side insulated from the secondary side.

Accordingly, the transferring unit 123 may transfer the control signals from the duty controlling unit 121 and the frequency controlling unit 122 of the secondary side, electrically insulated from the primary side, to the driving controlling unit 124 of the primary side.

To this end, the transferring unit 123 may include first and second photo-couplers OP1 and OP2 each transferring the control signals from the duty controlling unit 121 and the frequency controlling unit 122 of the secondary side to the driving controlling unit 124 of the primary side.

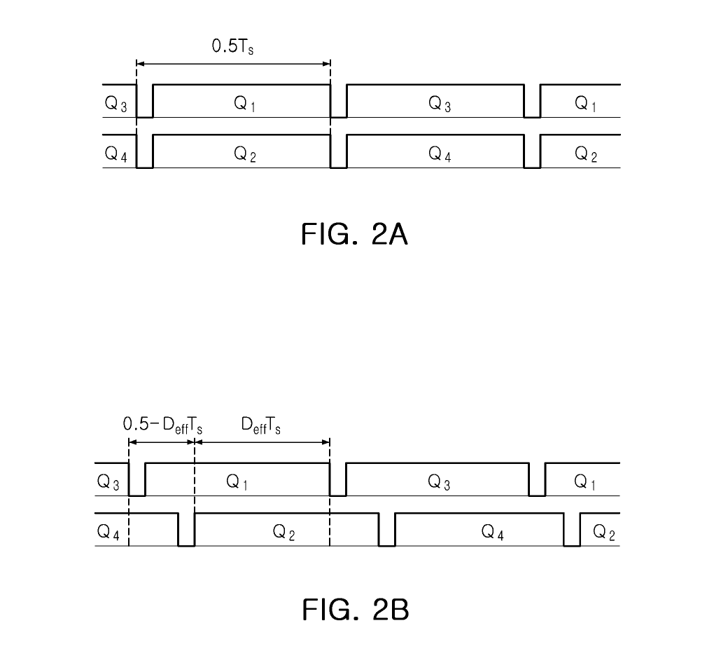

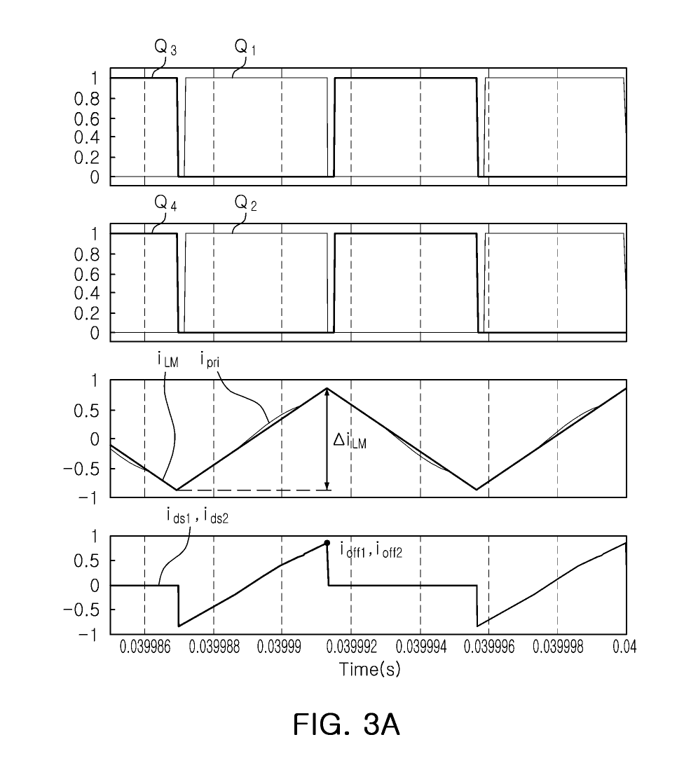

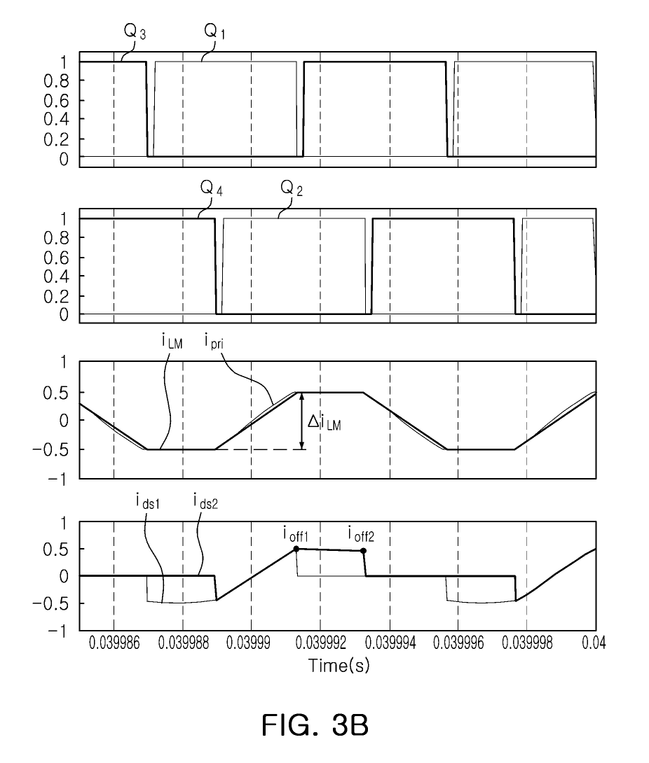

FIGS. 2A and 2B are graphs showing switching schemes depending on load states of the power supply apparatus according to an exemplary embodiment of the present disclosure. FIGS. 3A and 3B are graphs showing operational waveforms of main components according to the switching schemes of the power supply apparatus according to an exemplary embodiment of the present disclosure.

Referring to FIGS. 1 and 2A, the controlling unit 120 of the power supply apparatus 100 according to an exemplary embodiment of the present disclosure may control the switching of the switching unit 111 depending on a load state of the power supplying unit 110.

First, in a case in which the load state of the power supplying unit 110 is equal to or greater than a preset load state, that is, in the case of a heavy load state, power converting switching may be controlled by fixing a power switching phase and a power switching duty of the switching unit 111 of the power supplying unit 110 to preset values and varying a switching frequency thereof.

On the other hand, in a case in which the load state of the power supplying unit 110 is equal to or lower than the preset load state, that is, in the case of a light load state, the power converting switching may be controlled by varying the power switching phase and the switching frequency of the switching unit 111 of the power supplying unit 110.

For example, the controlling unit 120 may control a voltage regulation of the driving power of the power supplying unit 110 by fixing the phase to ‘0’ and the duty to ‘0.5’, and varying the switching frequency in a case in which the load state of the power supplying unit 110 is the heavy load state as shown in FIGS. 2A and 3A.

In addition, the controlling unit 120 may control the voltage regulation of the driving power of the power supplying unit 110 by fixing the duty to ‘0.5’, and varying the phase and the switching frequency in a case in which the load state of the power supplying unit 110 is the light load state as shown in FIGS. 2B and 3B, and may control a maximum value of a magnetized current iLM of the transformer T.

That is, in the case of the light load state, when the phase is increased, the maximum value of the magnetized current iLM is decreased and the magnetized current iLM is constantly maintained in a freewheeling section (0.5-DeffTs), such that turn-off currents in the switches Q1 to Q4 of the switching unit 111 may be significantly decreased. Therefore, in the case of the light load state, turn-off switching loss may be significantly decreased and the maximum value of the magnetized current iLM may be decreased, such that core loss may also be significantly decreased.

As set forth above, according to exemplary embodiments of the present disclosure, a power conversion operation may be controlled by varying a power switching phase and a switching frequency of switches of a phase-shift full-bridge in a light load condition, such that power conversion efficiency may be improved.

While exemplary embodiments have been shown and described above, it will be apparent to those skilled in the art that modifications and variations could be made without departing from the spirit and scope of the present disclosure as defined by the appended claims.

What is claimed is:

1. A power supply apparatus comprising:
a power supplying unit switching input power and supplying driving power; and
a controlling unit configured to control a supply of power by the power supplying unit by fixing a power switching phase and a power switching duty of the power supplying unit to preset values and varying a switching frequency of the power supplying unit when a load state of the power supplying unit is equal to or greater than a preset load state, and by varying the power switching phase and the switching frequency of the power supplying unit when the load state of the power supplying unit is equal to or lower than the preset load state.

2. The power supply apparatus of claim 1, wherein the power supplying unit includes:
a switching unit switching the input power according to a control of the controlling unit;
a transforming unit transforming the power switched by the switching unit; and
an outputting unit stabilizing and outputting the power transformed by the transforming unit.

3. The power supply apparatus of claim 2, wherein the switching unit performs the switching in a phase shift full bridge scheme.

4. The power supply apparatus of claim 2, wherein the transforming unit includes:
a resonance tank performing an inductor-inductor-capacitor (LLC) resonance; and
a transformer transforming the power switched by the switching unit according to a turns ratio between a primary winding and a secondary winding each having a predetermined amount of turns.

5. The power supply apparatus of claim 1, wherein the controlling unit includes:
a duty controlling unit detecting a current of the driving power from the power supplying unit and controlling the power switching duty;
a frequency controlling unit detecting a voltage of the driving power from the power supplying unit and controlling the switching frequency of the power supplying unit;
a driving controlling unit generating driving signals according to a control of the duty controlling unit and the frequency controlling unit; and
a gate driver providing gate signals allowing for switching of power according to the driving signals from the driving controlling unit.

6. The power supply apparatus of claim 5, wherein the duty controlling unit and the frequency controlling unit are formed at a secondary side having a preset ground,
the driving controlling unit and the gate driver are formed at a primary side having a ground having electrical characteristics different from those of the ground of the secondary side, and
the controlling unit further includes a transferring unit transferring control signals from the duty controlling unit and the frequency controlling unit of the secondary side to the driving controlling unit of the primary side.

7. A power supply apparatus comprising:
a power supplying unit switching input power in a phase shift full bridge scheme and supplying driving power; and
a controlling unit controlling supplying of power by the power supplying unit by fixing a power switching phase of the power supplying unit to a preset value and varying a switching frequency of the power supplying unit in a case in which a load state of the power supplying unit is equal to or greater than a preset load state, and by varying the power switching phase and the switching frequency of the power supplying unit in a case in which the load state of the power supplying unit is equal to or lower than the preset load state.

8. The power supply apparatus of claim 7, wherein the power supplying unit includes:
a switching unit switching the input power according to a control of the controlling unit;
a transforming unit transforming the power switched by the switching unit; and
an outputting unit stabilizing and outputting the power transformed by the transforming unit.

9. The power supply apparatus of claim 8, wherein the transforming unit includes:
a resonance tank performing an inductor-inductor-capacitor (LLC) resonance; and
a transformer transforming the power switched by the switching unit according to a turns ratio between a primary winding and a secondary winding each having a predetermined amount of turns.

10. The power supply apparatus of claim 7, wherein the controlling unit fixes a switching duty of the power supplying unit to a preset value in a case in which the load state of the power supplying unit is equal to or greater than a preset load state.

11. The power supply apparatus of claim 7, wherein the controlling unit includes:
a duty controlling unit detecting a current of the driving power from the power supplying unit and controlling a switching duty of the power supplying unit;
a frequency controlling unit detecting a voltage of the driving power from the power supplying unit and controlling the switching frequency of the power supplying unit;
a driving controlling unit generating driving signals according to a control of the duty controlling unit and the frequency controlling unit; and
a gate driver providing gate signals allowing for switching of power according to the driving signals from the driving controlling unit.

12. The power supply apparatus of claim 11, wherein the duty controlling unit and the frequency controlling unit are formed at a secondary side having a preset ground,
the driving controlling unit and the gate driver are formed at a primary side having a ground having electrical characteristics different from those of the ground of the secondary side, and
the controlling unit further includes a transferring unit transferring control signals from the duty controlling unit and the frequency controlling unit of the secondary side to the driving controlling unit of the primary side.
